(19) United States
(12) Patent Application Publication
(10) Pub. No.: US 2004/0078238 A1
(43) Pub. Date: Apr. 22, 2004

(54) Anonymizing tool for medical data

(76) Inventors: Carson Thomas, Brookfield, WI (US); Sally Lee, Ithaca, NY (US); Renuka Uppaluri, Peewaukee, WI (US)

Correspondence Address: ARTZ & ARTZ, P.C., 28333 TELEGRAPH RD., SUITE 250, SOUTHFIELD, MI, 48034, US

(21) Appl. No.: 10/063,981

(22) Filed: May 31, 2002

(51) Int. Cl. G06F 17/60

(52) U.S. Cl. 705/3

(57) ABSTRACT

An apparatus for anonymizing medical data 10 is provided, including a first communications input 39 receiving one or more patient files 22 which include a patient identifier 46, a pair list database 44 storing a plurality of related pair identifiers54 each of which includes one of the patient identifiers 46 and an associated anonymous identifier 48, a pair list retriever 56 to search the pair list database 44 to find a first associated anonymous identifier 48 paired with a first patient identifier 44, a pair list generator 58 to create a new associated anonymous identifier 48 to pair with a new patient identifier 46 forming a new related pair identifiers 54 added to the pair list database 44, and an anonymous file generator 62 that creates one or more anonymous files 42 from the one or more patient files 22 by replacing each of the patient identifiers 46 with an associated anonymous identifier 48 from the related pair identifiers 54.

### BACKGROUND OF INVENTION

The present invention relates generally to a method and apparatus for producing anonymous medical information, and more particularly, to a method and apparatus for updating coordinating anonymous medical information with corresponding patient identified information.

The medical field is constantly challenged with the need to integrate new practices, principles, and procedures into their operational framework. Once such challenge has arisen from the need to balance the rights of patient privacy with the needs of the research community for complete and detailed medical data. The use of medical data, such as medical diagnostic output and images, have become increasingly important in the research and development of medical technology. In order to properly support research and development, the acquired medical images and data will often need to be shared between hospitals and research and design facilities both internal and external to a given hospital. This desired free flow of information, however, must be carefully constructed to protect patient confidentiality.

The government and medical institutions have already begun to set regulations in order to protect such patient confidentiality. As a result, there is a need for concealing patient identity before transferring data and images outside the confidential confines of the patient care facility.

One approach commonly utilized to protect patient anonymity is referred to as an anonymizing process. Medical images are commonly encoded using the DICOM (digital image communication in medicine) standard. DICOM images have a header section that includes several fields, such as patient name, patient identification, birth date, hospital name, date of acquisition, techniques used for acquisition, etc. Key patient identifiable fields, such as, but not limited to patient name and patient ID, need to be anonymized before the images can be shared with research facilities. Present anonymizing processes commonly involve generating new images from the original images with such key patient identifiable fields replaced. Existing anonymization tools commonly involve a manual process of removing patient identifiable headers and replacing them with randomly generated identification numbers. Although present systems can succeed in preserving patient anonymity, they have undesirable limitations which can substantially lessen their value in many research applications.

One known flaw with present anonymizing procedures stems from the fact that individual diagnostic results or medical images are anonymized independently. The result of this methodology can result in diagnostic results and/or images from an individual patient's secondary or follow-up visits being assigned a unique anonymous header. As patient follow-up or continued care proceeds, the information sent to research facilities cannot therefore be traced or tracked as coming from a single patient. This can hamper the research facilities ability to monitor both an individual's medical progression as well as its ability to accurately access a statistical sample as the precise number of individual's submitted may be unknown. In addition to hampering research facilities, these procedures can also hamper advancements in patient care. Discoveries or analysis derived at the research level in regards to a specific or group of patient results cannot be retraced by the hospital or primary caregiver in order to apply these results or insights to a specific patient or group of patients. In this fashion, present anonymizing methodologies can hamper a physician's ability to utilize research and development results or discoveries for specific patients.

It would, therefore, be highly desirable to have an anonymizing method and apparatus that would provide a more complete set of medical records from a given patient to be provided to research and development while still reserving patient anonymity. Additionally, it would be further desirable to have an anonymizing method and apparatus that would allow information gleaned from the research and development level to be traceable back to specific patients by those physicians responsible for primary care.

### SUMMARY OF INVENTION

It is, therefore, an object of the present invention to provide an apparatus and method for anonymizing medical data with improved patient file continuity. It is a further object of the present invention to provide an apparatus and method for anonymizing medical data that allows for anonymous research and analysis results to be correlated with specific patient files by a patient's primary caregiver.In accordance with the objects of the present invention, an apparatus for anonymizing medical data is provided. The apparatus includes a first communications input receiving a plurality of patient files. Each of the plurality of patient files includes a patient identifier. The apparatus further includes a pair list database which stores a plurality of related pair identifiers, each of the plurality of related pair identifiers includes one of the patient identifiers and an associated anonymous identifier. A pair list retriever searches the pair list database to find a first associated anonymous identifier paired with a first patient identifier. A pair list generator creates a new associated anonymous identifier to pair with a new patient identifier. The new associated anonymous identifier and the new patient identifier comprise a new related pair of identifiers added to a pair list database. Finally, the apparatus includes an anonymous file generator that creates a plurality of anonymous files from a plurality of patient files by replacing each of the patient identifiers with an associated anonymous identifier from the related pair identifiers.Other objects and features of the present invention will become apparent when viewed in light of the detailed description of the preferred embodiment when taken in conjunction with the attached drawings and appended claims.

### BRIEF DESCRIPTION OF DRAWINGS

FIG. 1 is an illustration of an embodiment of an apparatus for anonymizing medical files in accordance with the present invention; and

FIG. 2 is a detailed flow diagram illustrating a method for anonymizing medical files in accordance with the present invention.

### DETAILED DESCRIPTION

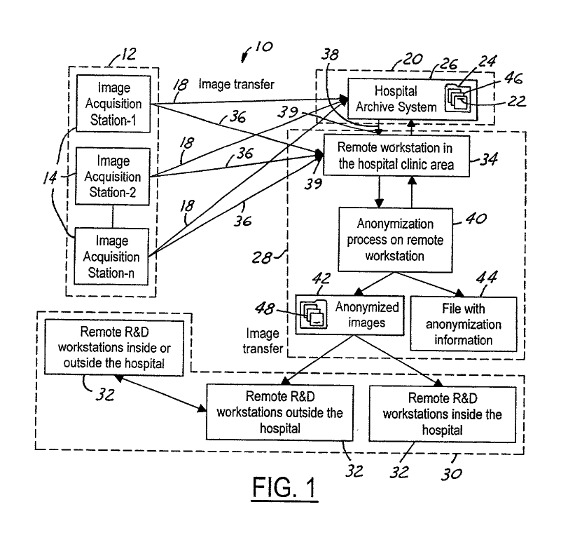

Referring now to FIG. 1, which is an illustration of an apparatus for anonymizing medical data 10. The apparatus for anonymizing medical images 10 is intended for use within a hospital or medical facility and is intended to serve as a liaison between the hospital's confidential departments and research and design facilities. It should be understood, however, that the apparatus for anonymizing medical data 10, although described in light of such a specific application, may have a variety of uses and applications that would be apparent to one skilled in the art. Furthermore, although the apparatus for anonymizing medical data 10 will be described in light of multiple physical systems, it should be understood that these systems may be combined into a multifunctional single system.

The apparatus for anonymizing medical data 10 is illustrated including a patient file development network 12. The patient file development network 12 is illustrated as comprising a plurality of image acquisition stations 14. The image acquisition stations 14 are contemplated to include a wide variety of medical imaging and patient diagnostic creation systems. Such systems include, but are not limited to, x-ray machines, magnetic resonance imaging systems, CT scan systems, and even simple data input computer systems. The image acquisition stations 14 are intended to encompass any system or methodology in which patient medical history information is developed. The patient file development network 12 has first communication links 18, connecting it with the primary patient care network 20 such that patient medical history or diagnostic information can be transferred from the image acquisition stations 14 to the primary patient care network 20. In one embodiment, patient files 22 (also known as images) are transferred from the image acquisition stations 14, where they were developed, to patient folders 24 contained within the primary patient care network 20.

The primary patient care network 20 is intended to represent any system in which confidential patient files 22 and folders 24 are stored and accessible. In a research hospital scenario, this may embody a segregated computer system wherein patient privacy may be secured. In other medical facility scenarios, however, it may simply be a central patient care computer system. The primary patient care network 20 is capable of receiving individual patient images 22 (or files) through the first communication links 24 and storing them within their appropriate patient folders 24. It is contemplated that the patient files 22 and folder 24 may be stored in a variety of systems, however a hospital archive system 26 is illustrated. Although the primary patient care network 20 is suitable for storing and managing confidential patient folders 24 and files 20, known primary care networks are often incapable of being accessed by outside research firms without the potential of breaching patient confidentiality.

The present invention, therefore, further includes an anonymization network system 28. As stated, the anonymization network system 28 can act as a liason between the primary patient care network 20, which requires strict patient confidentiality and a research and development network 30, which requires access to data. The research and development network 30 is contemplated to include a plurality of research and development workstations 32. These research and development workstations 32 can be located inside the hospital or outside the hospital. A remote hospital clinic workstation 34, within the anonymization network system 28, is utilized to automatically anonymize the confidential patient files 22 such that they can be safely transferred to outside research and development. Second communication links 36 place the patient file development network 12 in communication with the anonymization network system 28. Additionally, third communication links 38 can be utilized to place the primary patient care network 20 in communication with the anonymization network system 28. The use of second communications links 36 and/or third communication links 38 (collectively referred to as communication inputs 39), allows the patient files 20 to be routed to the anonymization network system 28 in a variety of fashions. One possibility allows the patient files 22, as they are developed by the patient file development network 12, to be transferred directly to the anonymization network system 28 at the same time as they are transferred to the primary patient care network 20. Another possibility, utilizing the third communication links 38, allows the anonymization network system 28 to process complete patient folders 24 held within the primary patient care network 20. This allows for a more fluid grouping of data to be provided to the research and development network 30.

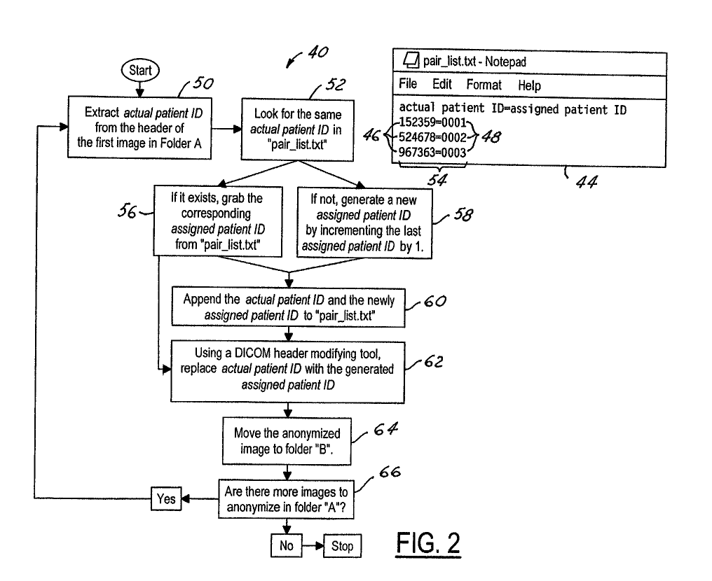

The anonymizing network system 28 utilizes an anonymizing process 40 to transform the confidential patient files 22 into anonymous files 42 (also known as anonymous images) and to develop a pair list database 44. The anonymizing process 40 accomplishes this task by transforming patient identifiers 46, located on the confidential patient files 22, into associated anonymous identifiers 48. A detailed description of this process is illustrated in FIG. 2. The anonymizing process 40 begins with an actual patient identifier extractor 50. The Extractor 50 pulls a first patient identifier 46 from the header of a first patient image 22 in a first patient folder 24. It should be understood that the patient identifiers 46 can represent any confidential patient data including, but not limited to, social security numbers, names, addresses, hospital patient codes, etc. Although such a variety of patient identifiers 46 are contemplated, the present invention preferably utilizes the DICOM header, normally found on patient images, as the patient identifier 46. Similarly, the associated anonymous identifiers 48 can represent any untraceable numbering system. After the first patient identifier 46 has been extracted from the patient image 22, it is sent to a pair list searcher 52.

The pair list searcher 52 searches the pair list database 44 for a reference to the first patient identifier 46. Each of the patient identifiers 46, for patients already processed, has an associated anonymous identifier 48 and they are stored together as related pair identifiers 54. A pair list retriever 56 grabs the first associated anonymous identifier 48 that is paired with the first patient identifier 46. If, on the other hand, a patient has not yet been processed, his patient identifier 46 will not yet reside in the pair list database 44. In this scenario, a pair list generator 58 creates a new associated anonymous identifier 48 to pair with the new patient identifier 46. The new associated anonymous identifier 48 and the new patient identifier 46 comprise new related pair identifiers 54. A pair list database appender 60 is utilized to add the new related pair identifiers 54 to the pair list database 44. Once either a set of related pair identifiers 54 has been recovered by the pair list retriever 56 or generated by the pair list generator 58, the results are sent to an anonymous file generator 62. The anonymous file generator 62 replaces the confidential patient identifier 46 with its associated anonymous identifier 48. This creates an anonymous file 42 that can be distributed to the research and development network 30 without concerns for patient confidentiality.

Although single anonymous files 42 may be processed by the anonymizing process 40, it is contemplated that groups of files or folders of files may be processed by the current system. In this fashion, existing patient databases stored on the primary patient care network 20 may be processed in total to send more complete anonymous records to the research and development network 30. This can be benefited, as previously discussed, through the use of the third communication links 38. The anonymizing process 40 can therefore include further routine elements to automatically handle large groupings of files. Such routine elements can include an anonymous file storage element 64 and a further file determination element 66. These additional elements can be utilized to allow the anonymizing process 40 to loop until all the selected patient files 22 or patient folder 24 are processed.

The present invention provides several benefits over prior art anonymizing methodologies. The automation of the anonymizing process 40 allows for a reduction in effort and man-power necessary to prepare patient files 22 for transfer to outside facilities. Additionally, patient files 22 are anonymized such that ever patient file 22 containing a specific patient identifier 46 is assigned an associated anonymous identifier 48 during the anonmizing process 40. This is true whether the patient files 22 are processed simultaneously or even days to years apart. This allows research and development networks 30 to develop closer studies of patient history and treatment without compromising patient confidentiality. Furthermore, results returned to the primary patient care network 20 from research and development can be safely traced back to a specific patient (allowing for improved patient care) through a primary care physician accessing the pair list database 44. Thus an effective two-way communication can be established between primary care networks 20 and research and development networks 30 without compromising patient confidentiality. In this fashion, improvements to the practices of each network, in addition to patient care, can be realized.

While particular embodiments of the invention have been shown and described, numerous variations and alternative embodiments will occur to those skilled in the art. Accordingly, it is intended that the invention be limited only in terms of the appended claims.

1. An apparatus for anonymizing medical data comprising:
a first communications input receiving one or more patient files, each of said one or more patient files including a patient identifier;
a pair list database storing a plurality of related pair identifiers, each of said plurality of related pair identifiers including one of said patient identifiers and an associated anonymous identifier;
a pair list retriever to search said pair list database to find a first associated anonymous identifier paired with a first patient identifier;
a pair list generator to create a new associated anonymous identifier to pair with a new patient identifier, said new associated anonymous identifier and said new patient identifier comprising a new related pair identifiers, said new related pair identifiers added to said pair list database;
an anonymous file generator creating one or more anonymous files from said one or more patient files by automatically replacing each of said patient identifiers with its said associated anonymous identifier taken from said related pair identifiers.

2. An apparatus as described in claim 1, wherein each of said patient identifiers includes a patient confidential data.

3. An apparatus as described in claim 1, further comprising:
a patient file development network in communication with said first communications input, said patient file development network sending said one or more patient files.

4. An apparatus as described in claim 3, wherein said patient file development network comprises at least one image acquisition station.

5. An apparatus as described in claim 1, further comprising:
at least one primary care network in communication with said first communications input, said at least one primary care network including a hospital archive system.

6. An apparatus as described in claim 1, further comprising:
at least one remote hospital clinic workstation storing said pair list database.

7. An apparatus as described in claim 1, further comprising:
a research and development network in communication with said an anonymous file generator, said research and development network receiving said one or more anonymous files.

8. An apparatus as described in claim 7, wherein said research and development network comprises at least one research and development workstation.

9. An apparatus as described in claim 5, further comprising:
a patient file development network in communication with said at least one primary care network, said patient file development network sending said one or more patient files to said at least one primary care network.

10. An apparatus for anonymizing medical data comprising:
a patient file development network, said patient file development network creating one or more patient files, each of one or more patient files including a patient identifier;
a primary care network in communication with said patient file development network, said at least one primary care network including a hospital archive system for storing said one or more patient files;
an anonymization network system including a first communications input for receiving said one or more patient files, said anonymization network system including a pair list database storing a plurality of related pair identifiers, each of said plurality of related pair identifiers including one of said patient identifiers and an associated anonymous identifier;
wherein said anonymization network system creates one or more anonymous files from said one or more patient files by automatically replacing each of said patient identifiers with its said associated anonymous identifier taken from said related pair identifiers.

11. An apparatus as described in claim 10, wherein said anonymization network system comprises at least one remote hospital clinic workstation.

12. An apparatus as described in claim 10, wherein said first communications input receives said one or more patient files from said patient file development network.

13. An apparatus as described in claim 10, wherein said first communications input receives said one or more patient files from said primary care network.

14. An apparatus as described in claim 10, further comprising:
a research and development network in communication with said anonymization network system, said research and development network receiving said one or more anonymous files from said anonymization network system.

15. An apparatus as described in claim 10, further comprising:
a pair list retriever to search said pair list database to find a first associated anonymous identifier paired with a first patient identifier.

16. An apparatus as described in claim 10, further comprising:
a pair list generator to create a new associated anonymous identifier to pair with a new patient identifier, said new associated anonymous identifier and said new patient identifier comprising a new related pair identifiers, said new related pair identifiers added to said pair list database.

17. A method of anonymizing medical data comprising:
extracting a patient identifier from a patient file;
searching a plurality of related pair identifiers contained in a pair list database for said patient identifier;
retrieving an associated anonymous identifier paired to said patient identifier from one of said related pair identifiers;
replacing said patient identifier with said associated anonymous identifier to create an anonymous file.

18. A method as described in claim 17, further comprising:
generating a new associated anonymous identifier to pair with said patient identifier if said searching a plurality of related pair identifiers fails to find said patient identifier in said pair list database.

19. A method as described in claim 17, further comprising:
appending said pair list database to include a new related pair identifiers comprising said new associated anonymous identifier and said patient identifier.

20. A method as described in claim 17, wherein said patient files are automatically received from a primary care network.

21. A method as described in claim 17, wherein said patient file is automatically received from a patient file development network.
